(19) United States
(12) Patent Application Publication
(10) Pub. No.: US 2025/0249752 A1
(43) Pub. Date: Aug. 7, 2025

(54) METHOD FOR MONITORING THE OPERATION OF A VEHICLE ELECTRICAL SYSTEM

(71) Applicant: Robert Bosch GmbH, Stuttgart (DE)

(72) Inventors: Yasen Iliev, Sofia (BG); Matthias Zabka, Suessen (DE); Slavcho Slavkov, Sofia (BG); Christel Sarfert, Korntal-Muenchingen (DE)

(21) Appl. No.: 18/853,200

(22) PCT Filed: Apr. 26, 2023
(86) PCT No.: PCT/EP2023/060883

§ 371 Date: Oct. 1, 2024

(30) Foreign Application Priority Data
May 17, 2022 (DE) 10 2022 204 829.6
Apr. 25, 2023 (DE) 10 2023 203 802.1

(51) Int. Cl. B60L 3/04; B60L 3/12

(52) U.S. Cl. CPC B60L 3/04; B60L 3/12; B60L 2240/525; B60L 2240/529; B60L 2260/165

(57) ABSTRACT

The invention relates to a method for monitoring the operation of a vehicle electrical system (50), in which the component temperature (62) of a component (56) in the vehicle electrical system channel (52, 54), the ambient temperature (66) of the component (56) and the current (70) flowing through the component (56) are ascertained in a vehicle electrical system channel (52, 54) of the vehicle electrical system (50), and then, if overloading of the component (56) is detected,
a period of time (72) to overloading of the component (56) is calculated,
   wherein a heat input (Pᵢₙ) into the component (56) and a heat loss (Pₒᵤₜ) of the component (56) are used to ascertain the period of time (72) to overloading of the component (56).

The invention relates to a method for monitoring the operation of a vehicle electrical system and an arrangement for carrying out the method.

### PRIOR ART

In automotive use, a vehicle electrical system, which is also referred to as a power supply system, is understood to mean the entirety of all electrical components in a motor vehicle. It therefore includes both electrical consumers and energy or supply sources, such as batteries. In a motor vehicle, care must be taken to ensure that electrical power is available in such a way that the motor vehicle can be started at any time, and that there is an adequate power supply during operation. But even when the vehicle is parked, electrical consumers should still be operable for a reasonable period of time without a subsequent start being impaired.

The vehicle electrical system therefore has the task of supplying power to the electrical consumers. It should be noted that, due to the increasing electrification of power units and the introduction of new vehicle functions, higher demands are being placed on the safety and reliability of the electrical power supply in the motor vehicle. This has to be taken into account in particular for safety-critical or safety-relevant consumers.

In an automotive vehicle electrical system, situations may occur with safety-critical consumers in which a vehicle electrical system channel, e.g. an output channel of an electronic power distributor or an ePDU or an output channel of a vehicle electrical system monitoring system or a Powernet Guardian (PNG), has to operate a consumer in overload in an emergency. It is then important to provide the needed current for as long as possible, but switch it off in a timely manner before overloading occurs in the vehicle electrical system channel in the form of a thermal incident.

In this case, a vehicle electrical system channel supplies a safety-relevant consumer, such as the electric brake or the steering. This usually also relates to a switch, e.g. a MOSFET, can disconnect the consumer from the vehicle electrical system in the event of a safety incident.

The objective is therefore to be able to predict how long a channel can be operated in overload before a critical state occurs and the channel may no longer be available.

A system for monitoring semiconductor components of a vehicle is known from DE 102019104246 A1. The system comprises at least one semiconductor component, at least one sensor unit which is disposed on or integrated in the at least one semiconductor component, wherein the at least one sensor unit is configured to acquire at least one operating parameter of the semiconductor component. A monitoring module is configured to ascertain a deviation between the acquired operating parameter and a reference.

DE 112018008225 T5 discloses an anomaly diagnosis device and an anomaly diagnostis method. These are configured to identify a remaining time until an electric motor and a load cause a fault or a defect.

### DISCLOSURE OF THE INVENTION

In light of this, a method having the features of Claim 1 and an arrangement according to Claim 13 are presented.

Embodiments will emerge from the dependent claims and from the description.

The presented method is used to monitor the operation of a vehicle electrical system. The method includes measuring the temperature of a component in the vehicle electrical system channel, the ambient temperature of the component and the current flowing through the component in a vehicle electrical system channel of the vehicle electrical system. If overloading of the component is detected, a time or period of time to overloading of the component is calculated. Overloading means that the component is operating in an operating state that does not correspond to its nominal operation, so that the heating of the component is outside the nominal range. Overloading means that the overload impairs the operation of the component and, in extreme cases, leads to its destruction.

In one embodiment, a temperature dependence of the electrical behavior of the component is taken into account. This can include the temperature dependence of the electrical resistance of the component, for instance.

The method can also be implemented for an output channel of an electronic power distributor or an output channel of a vehicle electrical system monitoring. system.

The presented method thus makes it possible to predict how long a vehicle electrical system channel can be operated in overload before overloading, i.e. a critical state, occurs and the vehicle electrical system channel has to be switched off.

The method is based on predicting a time or period of time that a specific current can be present in an output channel before thermal damage to the switching component can occur. This prediction of the remaining time then opens up further opportunities to implement an emergency measure that is optimized after the remaining time has elapsed if the power supply is overloaded by a safety-critical consumer.

An optimized emergency measure, i.e. one adapted to the situation, can be initiated or taken depending on the calculated period of time. After expiration of said period of time, the vehicle electrical system channel can be switched off.

The presented arrangement is used to carry out the method and is implemented in hardware and/or software, for example. The arrangement can be integrated in a control unit in a vehicle electrical system or configured as such.

Also presented is a vehicle electrical system that comprises a here described arrangement and is configured to carry out the presented method.

Further advantages and embodiments of the invention will emerge from the description and the accompanying drawings.

It goes without saying that the aforementioned features and the features yet to be explained in the following can be used not only in the respectively specified combination, but also in other combinations or on their own, without leaving the scope of the present invention.

### BRIEF DESCRIPTION OF THE DRAWINGS

FIG. 1 shows a flow chart of a possible sequence of the presented method.

FIG. 2 shows a schematic illustration of a vehicle electrical system comprising an arrangement for carrying out the method.

### EMBODIMENTS OF THE INVENTION

The invention is illustrated schematically in the drawings on the basis of embodiments and is described in detail in the following with reference to the drawings.

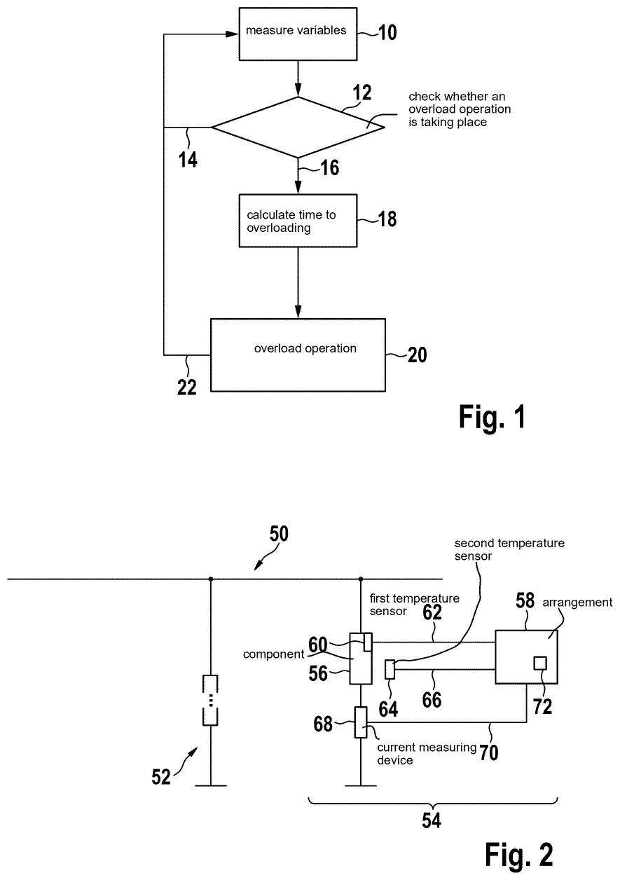

FIG. 1 shows a flow chart of a possible sequence of the here described method. Some of the variables used are shown in FIG. 2.

In a first step 10, the variables current 70 or i, component temperature 62 and ambient temperature 66 or T_{amb} are measured.

In a subsequent step 12, there is a check to see whether an overload operation is taking place. In the embodiment example, there is a check to see whether a heat input Pᵢₙ is greater than a heat loss Pₒᵤₜ. Either the heat input Pᵢₙ and/or the heat loss Pₒᵤₜ can be calculated, and/or other overload conditions derived from these variables are evaluated. The equations 1-3 discussed later can be used here.

The initial temperature Tstart of the component 56 could be used in equations 1 and 3 for a time tstart, for instance. The following overload condition could then be evaluated, for example:

$${i}^{2} * R > \frac{{T}_{start} - {T}_{amb}}{Rt}$$

wherein R: electrical resistance of the component 56 Rt: thermal resistance of the component 56, e.g. in K/W or:

$${i}^{2} * {R}_{20} ( 1 + ( T ( t ) - 20 ) * α ) > \frac{{T}_{start} - {T}_{amb}}{Rt}$$

if the temperature dependence of the electrical resistance R is taken into account.

If this is not the case (no overload operation), a jump (arrow 14) to step 10 takes place. If this is the case (arrow 16), the time t_{overload} to overloading is calculated in a step 18. In such a case then, an overload state or an impending overload is identified. This is followed in a step 20 with an overload operation. The variable t_{overload} is passed on or reported so that an optimum emergency measure can be selected. The method then jumps to step 10 again (arrow 22).

FIG. 2 shows a highly simplified schematic illustration of a vehicle electrical system which is labeled overall with the reference number 50. This vehicle electrical system 50 includes a first vehicle electrical system channel 52 and a second vehicle electrical system channel 54. A component 56, the operation of which is being monitored, is shown in the second vehicle electrical system channel 54. For this purpose, an arrangement 58 is provided, to which a first unit 60, for example a first temperature sensor 60, for acquiring a component temperature 62, a second unit 64, for example a second temperature sensor, for acquiring an ambient temperature 66, and a current measuring device 68 for measuring a current 70 flowing through the component 56 are assigned. The component 56 can be an electronic switch (for example a MOSFET) that, for instance, protects a safety-relevant consumer (for example an electrical brake or steering system) or safety-relevant branches of the vehicle electrical system. In the event of an impending fault, such as overload, overvoltage, etc., the safety-relevant consumer can be switched off by the component 56. In the event of a fault in a non-safety-relevant branch of the vehicle electrical system, the component 56 could also be used to disconnect the safety-relevant branch of the vehicle electrical system, in which safety-relevant consumers are supplied, for instance, from the faulty branch of the vehicle electrical system.

The unit 60 can be implemented with a temperature sensor or, for example, also using a thermal model of the component 56. The component temperature 62 can be inferred from certain operating variables of the component 56. It is therefore immaterial whether the component temperature 62 is measured directly or determined in some other way.

It is also possible that only an initial temperature Tstart of the component temperature 62 is acquired.

From the acquired variables, namely the component temperature 62, the ambient temperature 66 and the current 70, the arrangement 58 calculates a time or period of time 72 to overloading of the component 56 as described in more detail in the following. An overload operation of at least the second vehicle electrical system channel 54 or the entire vehicle electrical system 50 is initiated depending on this calculation by selecting and then also implementing an emergency measure. This can lead to the second vehicle electrical system channel 54 or even the entire vehicle electrical system 50 being switched off. A switch, for example a MOSFET, is typically used for this purpose.

The method is based on the fact that current flowing through an electronic component produces heat. This heat in turn produces heat in the element or in the component 56 as a function of its thermal capacity or heat capacity Ct. This also causes a flow of heat Pₒᵤₜ from the component 56 if the ambient temperature 66 or T_{amb} lower than the component temperature 62 or T itself. If this heat capacity Ct and the maximum permissible temperature at the component 56 before it is destroyed by heat are known, it is possible to calculate the time (or period of time 72 to overloading of the component 56) in which the current 70 or i can still flow to carry out a safety maneuver in an emergency.

However, this prediction is only valid if the current 70 or i remains constant. If a higher-level control unit takes over an emergency measure, it is expedient, for example in the event of an overload of an ABS channel (ABS: anti-lock braking system) and an emergency braking measure, to not only use the measured current 70 or i for the calculation of the remaining time (or period of time 72 to overloading of the component 56), but to instead use the measured current 70 or i plus an expected current increase resulting from the emergency measure, such as the measured current plus a nominal current, or carry out two separate calculations for an optimistic and a pessimistic time prediction.

The needed input variables are the current 70 or i, the component temperature 62 and the ambient temperature 66 or T_{amb}, for example.

The following variables contribute to ascertaining the period of time 72 to overloading of the component 56:

The heat loss Pₒᵤₜ (for example in W) of the component 56 due to the ambient temperature 66 (for example in degrees Celsius) or T_{amb} has to first be described or possibly calculated using the following equation:

$${P}_{out} = \frac{( T ( t ) - {T}_{amb} )}{Rt} \qquad Eq . 1$$

wherein T(t): the temporal progression of the component temperature 62 (for example in degrees Celsius), and
Rt: thermal resistance of the component 56, e.g. in K/W=C/W.

As an alternative to calculating Pₒᵤₜ at the beginning of an overload period or a potential overload period, a specific initial temperature Tₛₜₐᵣₜ of the component 62 could be used.

The heat input Pᵢₙ (for example in W) caused by the current 70 or i (for example in A) into the component 62 with its electrical resistance R (for example in ohms) can be described or calculated as follows:

$${P}_{in} = {i}^{2} * R \qquad Eq . 2$$

If the electrical or ohmic resistance R of the component 62 is temperature-dependent, this may need to be taken into account as well:

$${P}_{in} = {i}^{2} * {R}_{20} ( 1 + ( T ( t ) - 20 ) * α ) \qquad Eq . 3$$

wherein R20: electrical resistance R of the component 56 at 20° C. α Temperature factor, in ohms/K

The thermal differential equation for component 56 is also known:

$$\frac{dT ( t )}{dt} = \frac{( {P}_{in} - {P}_{out} )}{Ct} \qquad Eq . 4$$

wherein Ct: heat capacity of the component 56, e.g. in J/K Using equations 1 and 3, this then results in:

$$\frac{dT ( t )}{dt} + T ( t ) * {Rt}_{inv} * {Ct}_{inv} - {T}_{amb} * {Rt}_{inv} * {Ct}_{inv} - {i}^{2} * {R}_{20} ( 1 + ( T ( t ) - 20 ) * α ) * {Ct}_{inv} = 0 \qquad Eq . 5$$

And finally by solving the differential equation and solving for time and taking into account the condition T (tₒᵥₑᵣₗₒₐd)=T(end)

$${t}_{overload} = \frac{ln ( \frac{α {R}_{20} {T}_{end} {i}^{2} - 20 α {R}_{20} {i}^{2} + {R}_{20} {i}^{2} - {Rt}_{inv} {T}_{end} + {Rt}_{inv} {T}_{amb}}{\begin{matrix}α {R}_{20} {T}_{start} {i}^{2} - 20 α {R}_{20} {i}^{2} + \\ {R}_{20} {i}^{2} - {Rt}_{inv} {T}_{start} + {Rt}_{inv} {T}_{amb}\end{matrix}} )}{{Ct}_{inv} ( α {R}_{20} {i}^{2} - {Rt}_{inv} )} \qquad Eq . 6$$

Pᵢₙ: heat input
Pₒᵤₜ: heat loss
T_{amb}: ambient temperature 66
R₂₀: electrical resistance at 20° C.
Rₜᵢₙᵥ: inverted thermal resistance Rₜᵢₙᵥ=1/Rt
Cₜᵢₙᵥ: inverted thermal capacity Ctᵢₙᵥ=1/Ct
a: temperature correction factor for the electrical resistance per degree Celsius
t_{overload}: the period of time 72 to overloading of the component 56
Tₛₜₐᵣₜ: initial temperature of the component 56

If the temperature dependence of the component 56 is not taken into account, the formula is simplified at a temperature correction factor α equal to zero to:

$${t}_{overload} = \frac{ln ( \frac{{R}_{20} {i}^{2} - {Rt}_{inv} {T}_{end} + {Rt}_{inv} {T}_{amb}}{{R}_{20} {i}^{2} - {Rt}_{inv} {T}_{start} + {Rt}_{inv} {T}_{amb}} )}{{Ct}_{inv} ( - {Rt}_{inv} )} \qquad Eq . 7$$

The presented method is in particular suitable to be used in conjunction with Powernet Guardians to thus increase the availability of vehicle electrical system channels.

1-14. (canceled)

15. A method for monitoring an operation of a vehicle electrical system, the method comprising the following steps:
ascertaining, in a vehicle electrical system channel of the vehicle electrical system, a component temperature of a component in the vehicle electrical system channel, an ambient temperature of the component, and a current flowing through the component;
in response to detecting an overloading of the component, calculating a period of time to the overloading of the component;
wherein a heat input into the component and a heat loss of the component are used to ascertain the period of time to the overloading of the component.

16. The method according to claim 15, wherein the heat loss (Pₒᵤₜ) is ascertained as a function of the component temperature (T(t)), an ambient temperature (T_{amb}), and/or a thermal resistance (Rt) of the component, using the following formula:
$${P}_{out} = \frac{( T ( t ) - {T}_{amb} )}{Rt} .$$

17. The method according to claim 15, wherein the heat input (Pᵢₙ) is ascertained as a function of the current, (i), an electrical resistance (R) of the component, and an initial temperature (Tstart) of the component, using the following formula: Pᵢₙ=i²*R.

18. The method according to claim 17, wherein the electrical resistance (R) of the component is temperature-dependent.

19. The method according to claim 15, wherein the period of time to the overloading of the component is ascertained using a thermal differential equation:
$$\frac{dT ( t )}{dt} = \frac{( {P}_{in} - {P}_{out} )}{Ct} ,$$
wherein T(t) is a temporal progression of the component temperature, Pᵢₙ is the heat input, Pₒᵤₜ is the heat loss and Ct is a heat capacity of the component.

20. The method according to claim 15, wherein an overload operation is identified when the heat input exceeds the heat loss.

21. The method according to claim 15, wherein the method is carried out for an output channel of an electronic power distributor and/or a vehicle electrical system monitoring system and/or in which an electronic switch is used as the component to control a safety-relevant consumer.

22. The method according to claim 15, wherein an adapted emergency measure for the vehicle electrical system channel is taken as a function of the calculated period of time to the overloading in overload operation.

23. The method according to claim 15, in which an increase in current caused by the emergency measure is taken into account in the calculation of the period of time to overloading.

24. The method according to claim 15, wherein the vehicle electrical system channel is switched off as a function of the calculated period of time to overloading.

25. The method according to claim 15, wherein the period of time (t_{overload}) to the overloading is calculated using the following equation:
$${t}_{overload} = \frac{ln ( \frac{α {R}_{20} {T}_{end} {i}^{2} - 20 α {R}_{20} {i}^{2} + {R}_{20} {i}^{2} - {Rt}_{inv} {T}_{end} + {Rt}_{inv} {T}_{amb}}{α {R}_{20} {T}_{start} {i}^{2} - 2 α {R}_{20} {i}^{2} + {R}_{20} {i}^{2} - {Rt}_{inv} {T}_{start} + {Rt}_{inv} {T}_{amb}} )}{{Ct}_{inv} ( α {R}_{20} {i}^{2} - {Rt}_{inv} )} .$$
wherein R₂₀ is an electrical resistance R of the component at 20° C., Tₛₜₐᵣₜ is an initial temperature of the component, α: is temperature correction factor for the electrical resistance per degree Celsius, Rₜᵢₙᵥ is an inverted thermal resistance, T_{amb} is an ambient temperature of the component, Cₜᵢₙᵥ is inverted thermal capacity of the component.

26. An arrangement for monitoring an operation of a vehicle electrical system, the arrangement configured to:
ascertain, in a vehicle electrical system channel of the vehicle electrical system, a component temperature of a component in the vehicle electrical system channel, an ambient temperature of the component, and a current flowing through the component;
in response to detecting an overloading of the component, calculate a period of time to the overloading of the component;
wherein a heat input into the component and a heat loss of the component are used to ascertain the period of time to the overloading of the component.

27. The arrangement according to claim 26, wherein the arrangement comprises:
a temperature sensor configured to acquire the component temperature of the component of a vehicle electrical system;
a temperature sensor configured to acquire the ambient temperature of the component; and
a current measuring device configured to measure the current flowing through the component.
